(19) United States
(12) Patent Application Publication
(10) Pub. No.: US 2016/0379549 A1
(43) Pub. Date: Dec. 29, 2016

(54) DISPLAY DEVICE

(71) Applicant: Japan Display Inc., Tokyo (JP)

(72) Inventors: Takashi Yoshii, Tokyo (JP); Tetsuya Yamamoto, Tokyo (JP)

(21) Appl. No.: 15/188,840

(22) Filed: Jun. 21, 2016

(30) Foreign Application Priority Data
Jun. 24, 2015 (JP) 2015-126544

(51) Int. Cl. G09G 3/20

(52) U.S. Cl. CPC G09G 3/2096; G09G 2330/02

(57) ABSTRACT

According to one embodiment, a display device includes a display and a driver. The display displays an image. The driver supplies a drive signal to the display. The driver determines, if power to drive the driver is supplied from power sources, whether a sequence of supplying the power is a predetermined sequence. A status of the driver remains as a status in which various commands are unacceptable in the case being determined that the sequence of supplying the power is not the predetermined sequence. The status of the driver is shifted to a status in which the various commands supplied to the driver are acceptable in the case being determined that the sequence of supplying the power is the predetermined sequence.

### CROSS-REFERENCE TO RELATED APPLICATIONS

This application is based upon and claims the benefit of priority from Japanese Patent Application No. 2015-126544, filed Jun. 24, 2015, the entire contents of which are incorporated herein by reference.

### FIELD

Embodiments described herein relate generally to a display device.

### BACKGROUND

In general, mobile terminals (for example, smartphones, PDAs, tablet computers and the like) are provided with a liquid crystal display device or an organic EL display device. A drive signal of the display device is controlled by a liquid crystal driver in the mobile terminal. The liquid crystal driver is supplied with electric power such as logic power or analog power to drive the own liquid crystal driver.

The liquid crystal driver is supplied with several types of power at the power-on or the like, but is often supplied with the power not in a particular sequence, but in a wrong sequence. At this time, the liquid crystal driver often turns off a sleep status (i.e., sleeps out) and starts a boosting operation, irrespective of the detection of an error in the power supply sequence. As a result, inconvenience that a large current unexpectedly flows to each module inside the liquid crystal driver (i.e., a latch-up occurs), the liquid crystal driver does not operate normally or the like may occur.

### BRIEF DESCRIPTION OF THE DRAWINGS

FIG. 1 is an illustration showing overall blocks of a mobile terminal of the embodiments.

FIG. 2 is a diagram showing major circuit blocks as parts of FIG. 1.

FIG. 3 is a diagram schematically showing an equivalent circuit on a first substrate of a liquid crystal display panel.

FIG. 4 is a diagram showing an equivalent circuit of a pixel PX shown in FIG. 3.

FIG. 5A is an illustration showing a basic configuration example of a mutual detection type touch sensor SE.

FIG. 5B is a timing chart showing a relationship between drive timing of the touch sensor SE in FIG. 5A and a display period, in the liquid crystal display panel.

FIG. 6 is a block diagram showing an example of block configuration in a liquid crystal driver IC1 of a first embodiment.

FIG. 7A is a diagram showing a configuration example of a power supply module in the liquid crystal driver IC1 shown in FIG. 6.

FIG. 7B is a diagram showing a configuration example of a power supply module in the liquid crystal driver IC1 shown in FIG. 6.

FIG. 8 is a flow chart showing an example of operations of a monitoring circuit in the liquid crystal driver IC1 shown in FIG. 6.

FIG. 9 is a timing chart to additionally explain the example of operations of the monitoring circuit in the liquid crystal driver IC1 shown in FIG. 6.

FIG. 10 is a block diagram showing a block configuration in a liquid crystal driver IC1 of a second embodiment.

FIG. 11 is a flow chart showing an example of operations of a monitoring circuit in the liquid crystal driver IC1 shown in FIG. 10.

FIG. 12 is a timing chart to additionally explain the example of operations of the monitoring circuit in the liquid crystal driver IC1 shown in FIG. 10.

FIG. 13 is a block diagram showing a modified example of the second embodiment.

### DETAILED DESCRIPTION

In general, according to one embodiment, a display device includes a display and a driver. The display displays an image. The driver supplies a drive signal to the display. The driver determines, if power to drive the driver is supplied from power sources, whether a sequence of supplying the power is a predetermined sequence. A status of the driver remains as a status in which various commands are unacceptable in the case being determined that the sequence of supplying the power is not the predetermined sequence. The status of the driver is shifted to a status in which the various commands supplied to the driver are acceptable in the case being determined that the sequence of supplying the power is the predetermined sequence.

Embodiments will be described hereinafter with reference to the accompanying drawings. The disclosure is a mere example, and arbitrary change of gist which can be easily conceived by a person of ordinary skill in the art naturally falls within the inventive scope. To further clarify the explanations, the drawings may pictorially show width, thickness, shape, etc., of each portion as compared with an actual aspect, but they are mere examples and do not restrict the interpretation of the invention. In the drawings, reference numerals of the same or similar elements arranged sequentially are often omitted. Furthermore, in the specification and drawings, constituent elements having the same or similar functions as those described with reference to preceding drawings are denoted by the same or similar reference numerals and duplicated detailed explanations may be arbitrarily omitted.

### First Embodiment

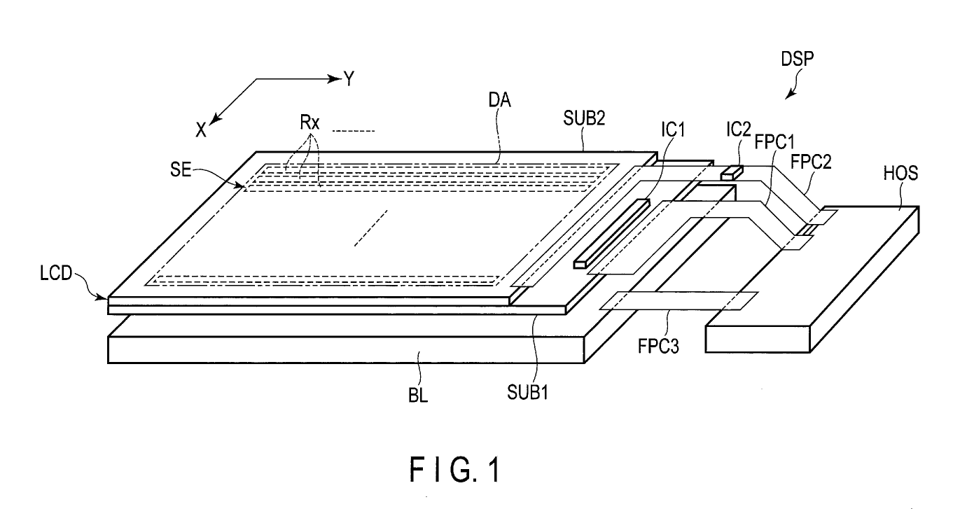

FIG. 1 is an illustration showing overall blocks of a mobile terminal of the embodiments. In FIG. 1, a touch-sensor-integrated liquid crystal display panel LCD includes a first substrate SUB1, a second substrate SUB2 opposed to the first substrate SUB1, and a liquid crystal layer formed between the first substrate SUB1 and the second substrate SUB2. The first substrate SUB1 may be referred to as an array substrate and the second substrate SUB2 may be referred to as a counter-substrate. A liquid crystal driver IC1 configured to drive the liquid crystal display panel LCD is mounted on the first substrate SUB1. The liquid crystal driver IC1 may be referred to as a first IC chip or a drive circuit.

The liquid crystal display panel LCD integrally includes, for example, a touch sensor SE of a capacity variation detection type in a display area DA which may be referred to as an active area. The touch sensor SE is composed of a common electrode C disposed on the first substrate SUB1, which will be explained later, and a touch detection electrode Rx disposed on the second substrate SUB2, which may be referred to as a touch detection element. The touch sensor SE of this type is called an in-cell touch sensor. The operation principle of the in-cell touch sensor SE will be explained later. The touch detection element Rx can be formed of, for example, transparent Indium-Tin-Oxide (ITO) or a thin metal wire having a thickness ranging from several nanometers to some tens of nanometers, so as not to affect the liquid crystal display.

The touch sensor SE is driven by a drive signal from the liquid crystal driver IC1, and an output signal of the touch sensor SE is detected by a touch panel controller IC2 which may be referred to as a second IC chip or a sensor circuit.

In addition, the liquid crystal display panel LCD is electrically connected to an application processor HOS which may be referred to as a first controller. More specifically, the application processor HOS is connected to the liquid crystal display panel LCD via a flexible printed circuit FPC1 and the liquid crystal driver IC1, and is also connected to the touch sensor SE via a flexible printed circuit FPC2 and the touch panel controller IC2. The liquid crystal driver IC1 and the touch panel controller IC2 are electrically connected with each other to be synchronized by a timing pulse or the like. The liquid crystal driver IC1 and the touch panel controller IC2 may be configured in the same chip.

A backlight unit BL configured to illuminate the liquid crystal display panel LCD is disposed under the second substrate SUB2. A flexible printed circuit FPC3 connects the backlight unit BL and the application processor HOS.

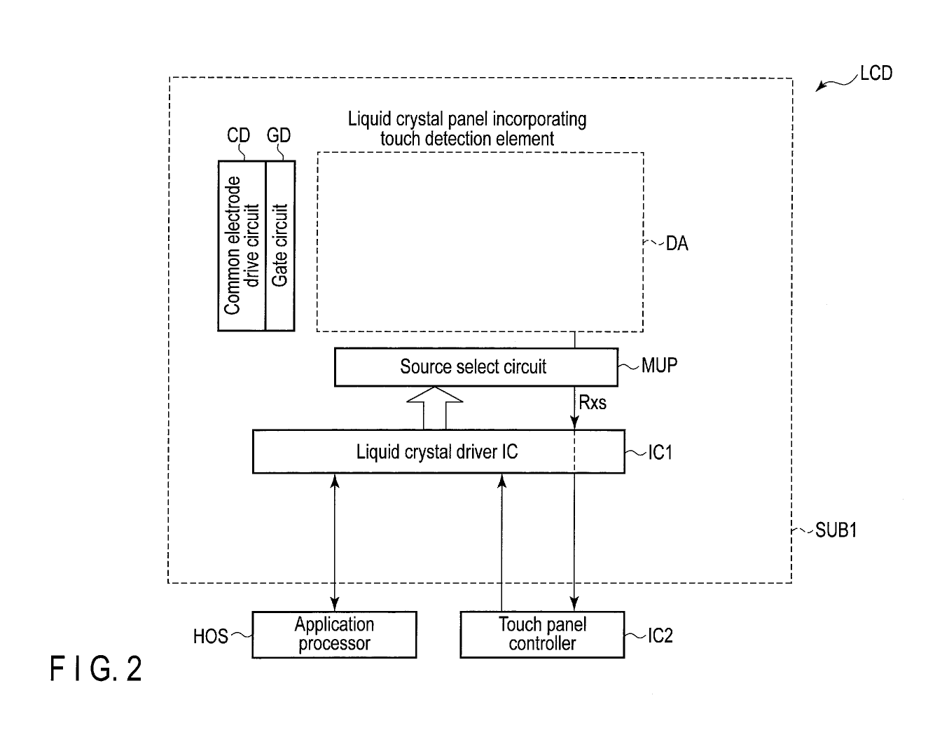

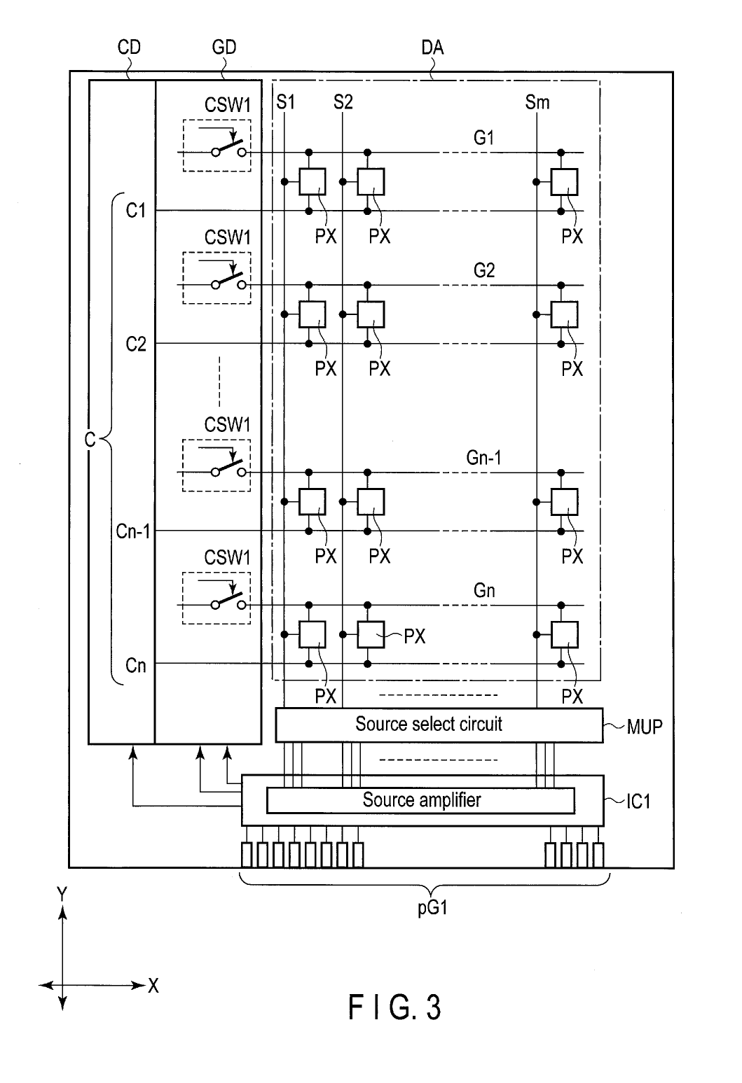

FIG. 2 specifically illustrates major circuit blocks as parts of FIG. 1. A portion surrounded by a broken line in FIG. 2 corresponds to the first substrate SUB1. A gate drive circuit GD is formed in, for example, a left area of a non-display area of the first substrate SUB1. The gate drive circuit GD drives gate lines G (G1 to Gn), which are specifically shown in FIG. 3. In addition, a common electrode drive circuit CD is disposed together with the gate drive circuit GD. The common electrode drive circuit CD drives common electrodes C (C1 to Cn), which are specifically shown in FIG. 3. In addition, a source select circuit MUP, which is often referred to as a multiplexer, is disposed in a non-display area on a lower side of the first substrate SUB1. The gate drive circuit GD is formed on either side in FIG. 2 and FIG. 3, but gate drive circuits GD may be formed on both sides to sandwich the display area DA. In this case, the gate drive circuit GD located on one of the sides, for example, the gate drive circuit GD located on the right side of the display area DA may drive gate lines G1, G3, . . . located in odd-numbered rows, of the gate lines G1 to Gn, and the gate drive circuit GD located on the other side, for example, the gate drive circuit GD located on the left side of the display area DA may drive gate lines G2, G4, . . . located in even-numbered rows, of the gate lines G1 to Gn.

The liquid crystal driver IC1 controls the gate drive circuit GD, the common electrode drive circuit CD and the like. In addition, the liquid crystal driver IC1 writes a pixel signal to a pixel PE, which may be referred to as a display element, in the display area DA via the source select circuit MUP.

The touch panel controller IC2 can process touch detection signals Rxs obtained from the touch detection elements Rx and obtain coordinate data on a contact position at which a detected object such as a user's finger is contact with the display surface of the liquid crystal display panel LCD. The liquid crystal driver IC1 executes intercommunication with the application processor HOS for data request and reception or the like.

The application processor HOS supplies video data, commands, synchronization signals and the like to the liquid crystal driver IC1.

FIG. 3 schematically shows one of equivalent circuits on the first substrate SUB1 of the liquid crystal display panel LCD. The liquid crystal display panel LCD includes the display area DA on which an image is displayed. In addition, the source select circuit MUP, the gate drive circuit GD, the common electrode drive circuit CD, and an outer lead bonding pad group pG1 which is hereinafter referred to as an OLB pad group are formed in the non-display area formed to surround the display area DA.

The liquid crystal driver IC1 is connected to the source select circuit MUP, the gate drive circuit GD, the common electrode drive circuit CD and the OLB pad group pG1. The liquid crystal driver IC1 and the gate drive circuit GD are connected with each other by a control line in which a panel control signal is output, though not shown entirely. The liquid crystal driver IC1 can supply the control signal to a control switching element CSW1 by the control line.

The first substrate SUB1 includes the gate lines G (G1 to Gn) extending along a first direction X and source lines S (S1 to Sm) extending along a second direction Y which intersects the first direction X, in the display area DA. In addition, the gate lines G (G1 to Gn) are arranged in the second direction Y so as to be spaced apart at regular intervals. The source lines S (S1 to Sm) are also arranged in the first direction X so as to be spaced apart at regular intervals.

In the display area DA, pixels PX are formed in areas sectioned by the gate lines G and the source lines S in planar view. In other words, the pixels PX are arrayed in a matrix of m×n in the first direction X and the second direction Y, in the display area, where m and n are positive integers. Furthermore, the common electrodes C (C1 . . . Cn) included in the configuration of the pixels PX are formed along the first direction X, used as electrodes configured to drive the pixels PX and also used as electrodes configured to drive the touch sensor SE as explained later.

Each of the gate lines G is drawn to the outside of the display area DA and connected to the gate drive circuit GD. The gate drive circuit GD includes control switching elements CSW1, and the gate lines G (G1, G2, . . . Gn) are connected to the control switching elements CSW1 in a one-to-one relationship.

Each of the source lines S (S1 to Sm) intersects the gates G (G1, G2, . . . Gn) in planar view. The source lines S are arranged in the first direction X so as to be spaced apart at regular intervals. The source lines S (S1 to Sm) are drawn to the outside of the display area DA and connected to the source select circuit MUP.

The common electrodes C (C1, C2, . . . Cn) are formed in a stripe shape, extend in the first direction X, and are arranged in the second direction Y so as to be spaced apart at intervals. The common electrodes C (C1, C2, . . . Cn) thereby extend along the gate lines G (G1, G2, . . . Gn) and intersect the source lines S (S1 to Sm) in planar view. The common electrodes C can also be formed in the respective pixel areas and connected to each other by auxiliary lines. The common electrodes C extend along the gate lines G and intersect the source lines S in planar view, but may be formed to extend along the source lines S and intersect the gate lines G in planar view.

The common electrodes C may be, for example, divisional electrodes in which every plural, for example, three electrodes are bundled. For example, the common electrodes C (C1 to Cn) are formed as (n/3) divisional electrodes C (C1/3 to Cn/3).

The common electrodes C are drawn to the outside of the display area DA and connected to the common electrode drive circuit CD. The gate lines G, the source lines S and the common electrodes CE may not extend linearly as shown in the figure, but may be bent in part.

The gate drive circuit GD includes n control switching elements CSW1. Each of n control switching elements CSW1 can be selectively turned on or off to control permission or prohibition of writing of an image signal to the corresponding pixel PX.

The pixel signal is written to the pixels PX connected to the selected gate line, simultaneously, via the source select circuit MUP.

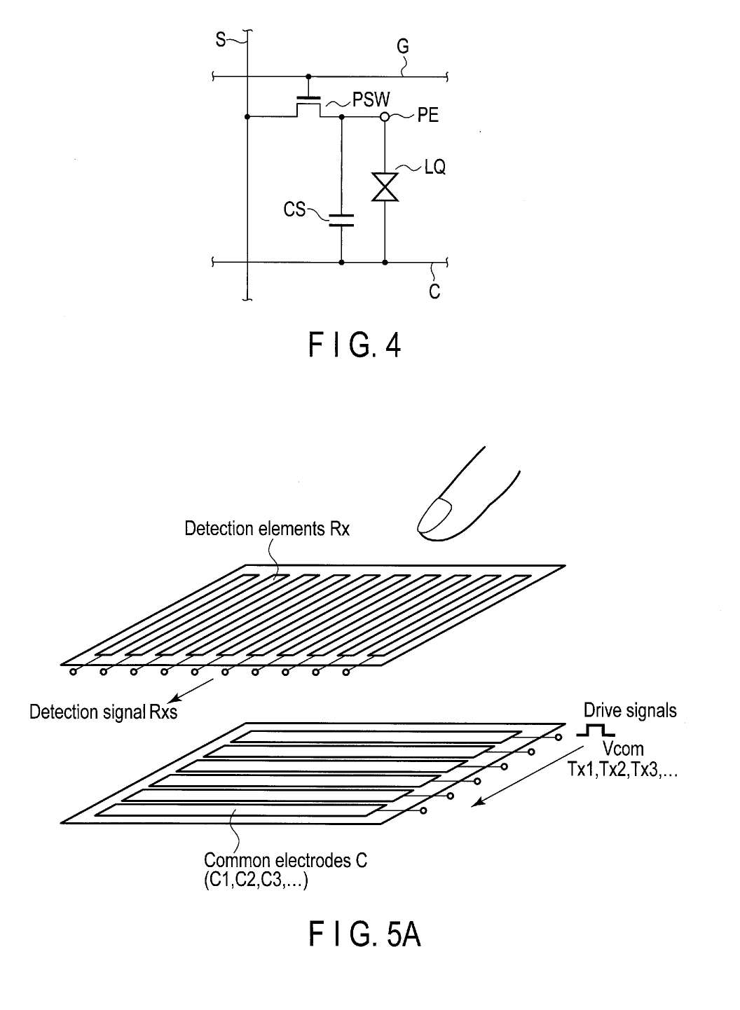

FIG. 4 is an equivalent circuit diagram showing one of the pixels PX shown in FIG. 3. The pixel PX includes a pixel switching element PSW, a transparent pixel electrode PE, a transparent common electrode C and the like, which are formed on the first substrate SUB1. The pixel switching element PSW is formed based on, for example, a thin film transistor (TFT). The pixel switching element PSW is electrically connected to the gate line G and the source line S. The pixel switching element PSW may be a top-gate TFT or a bottom-gate TFT. A semiconductor layer of the pixel switching element PSW is formed of, for example, polysilicon, but may be formed of amorphous silicon.

The pixel electrode PE is electrically connected to the pixel switching element PSW. The pixel electrode PE is formed of ITO and opposed to the common electrode C through an insulating film. A storage capacitor CS is formed by the common electrode C, an insulating film and the pixel electrode PE. When the pixel switching element PSW is turned on by the control signal from the gate line G, the pixel signal output from the source select circuit MUP to the source line S is written to the storage capacitor CS and then held. Spatial light modulation of the liquid crystal LQ between the pixel electrode PE and the common electrode CE is implemented in response to the voltage generated at the storage capacitor CS. Only one pixel PX is illustrated in FIG. 4 but, when one of the control switching elements CSW1 shown in FIG. 2 is turned on, the pixel switching elements PSW of the pixels connected to the corresponding gate line G are turned on simultaneously. The pixel signal from the source line S connected to the pixel switching element PSW is therefore written to the storage capacitor CS of the corresponding pixel PX.

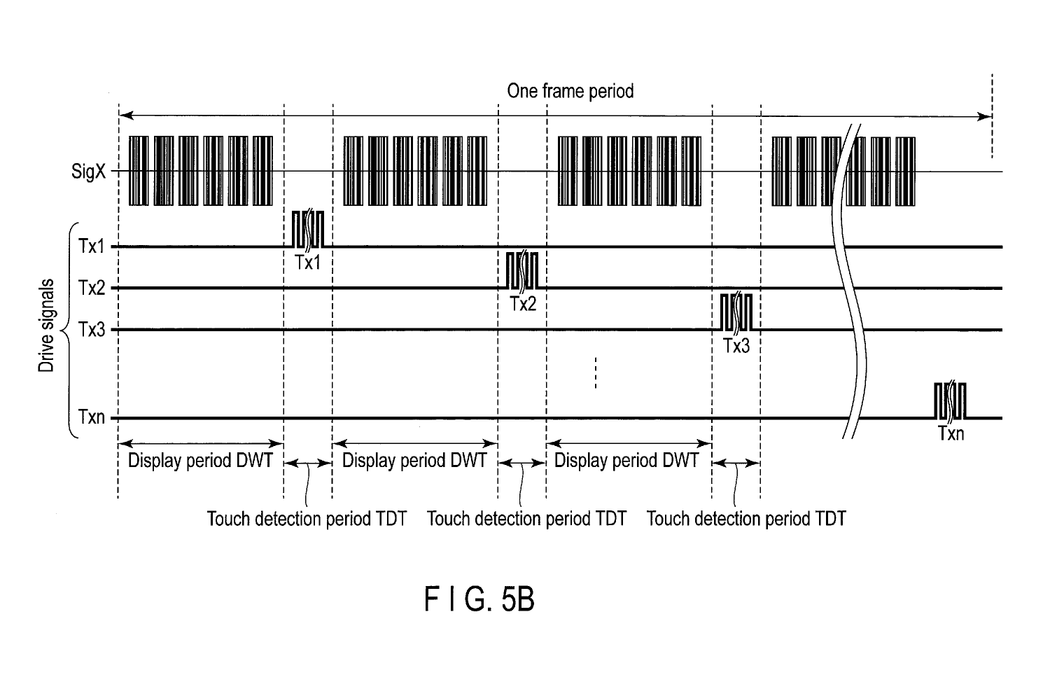

FIG. 5A and FIG. 5B are illustrations for explanation of a basic operation of the in-cell touch sensor SE.

FIG. 5A illustrates a mutual (mutual-capacitive) detection touch sensor SE. The touch detection elements Rx are formed in a stripe shape in the second direction Y, on the second substrate SUB2, and the common electrodes C (C1, C2, C3, . . . ) are formed on the first substrate SUB1. The touch detection elements Rx and the common electrodes C (C1, C2, C3, . . . ) intersect each other.

In a touch detection period TDT which will be explained later, the common electrodes C (C1, C2, C3, . . . ) are sequentially driven by radio-frequency pulse-like drive signals Tx1, Tx2, Tx3, . . . In this period, for example, from the touch detection element Rx to which a detected object such as a finger is close, a detection signal Rxs of a lower level compared with the outputs from the other touch detection elements Rx is detected. This is because a first capacitance is not only generated between the touch detection element Rx to which the finger is close and the common electrode, but a second capacitance is also generated between the touch detection element Rx and the finger. The second capacitance is not generated between the other touch detection elements Rx and the common electrodes, by the finger, but the first capacitance alone is generated between the other touch detection elements Rx and the common electrodes.

The coordinate position of the finger can be determined based on the drive timing of the common electrodes C1, C2, C3, . . . and the position of the touch detection element Rx which outputs the lower-level detection signal Rxs.

FIG. 5B shows a timing chart formed when the common electrodes C (C1, C2, C3, . . . ) are driven by the drive signals Tx1, Tx2, Tx3, . . . As shown in FIG. 5B, one frame period is divided into display periods DWT, which include periods of writing a pixel signal SigX, and touch detection periods TDT which may be referred to as non-display periods TDT are set between the display periods DWT. In the touch detection periods TDT, the common electrodes C (C1, C2, C3, . . . ) are driven by the drive signals Tx1, Tx2, Tx3, . . . In FIG. 5B, for example, the common electrodes C are driven by the drive signal Tx1 in the first touch detection period TDT, the common electrodes C are driven by the drive signal Tx2 in the second touch detection period TDT, and the common electrodes C are driven by the drive signal Txn in the n-th touch detection period TDT. However, the common electrodes C may be driven by sequentially inputting the drive signals Tx1 to Txn in the respective touch detection periods TDT. In other words, the common electrodes C may be driven by the sequentially input drive signals Tx1 to Txn in the first touch detection period TDT, the common electrodes C may also be driven by the sequentially input drive signals Tx1 to Txn in the second touch detection period TDT, and the common electrodes C may also be driven by the sequentially input drive signals Tx1 to Txn in the n-th touch detection period TDT.

As shown in FIG. 5B, the display periods DWT and the touch detection periods TDT are dispersed at plural positions in one frame. The basic configuration and operations of the in-cell touch sensor SE have been explained above.

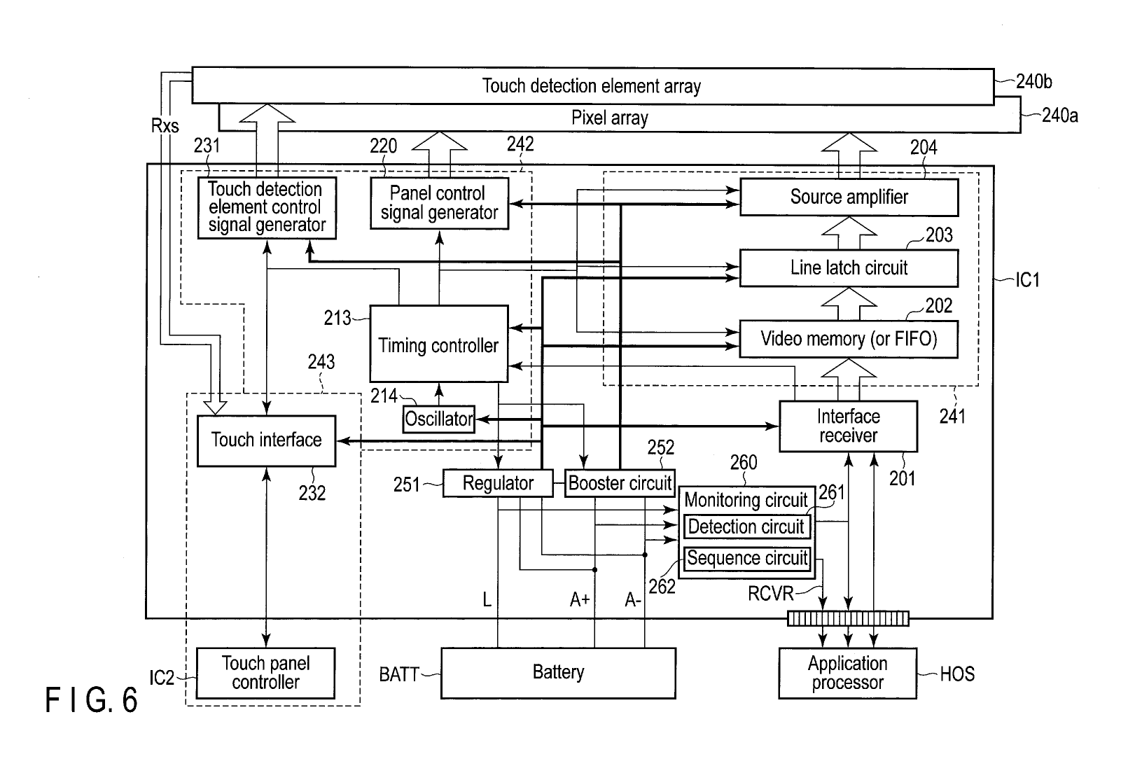

Next, an example of the block configuration in the liquid crystal driver IC1 which is an IC chip will be explained in detail with reference to FIG. 6.

In FIG. 6, video data from the application processor HOS is input to a video memory 202 via an interface receiver 201. The video data read from the video memory 202 is latched by a line latch circuit 203. The line latch circuit 203 can latch the video data of one or plural lines of the liquid crystal display panel LCD.

The video data corresponding to each pixel PX read from the line latch circuit 203 is digital-analog-converted by a source amplifier 204, and subjected to gamma correction by an amplifier to become a pixel signal. The pixel signal is written to each of the pixels PX arrayed in the pixel array 240a of the liquid crystal display panel LCD. More specifically, the pixel signal is input to the pixels PX two-dimensionally arrayed in the display area DA via the source select circuit MUP shown FIG. 2. Then, the pixel signal is written to the storage capacitor CS explained with reference to FIG. 4.

A block including the video memory 202, the line latch circuit 203, the source amplifier 204 and the like may be referred to as a video data processor 241.

Furthermore, the synchronization signal, the command and the like from the application processor HOS are taken in by the interface receiver 201. The synchronization signal taken in by the interface receiver 201 is input to the timing controller 213. In addition, the command taken in via the interface receiver 201 is once input to a register (not shown) and interpreted, and its result is reflected on timing pulse generation of the timing controller 213, and the like. The interface receiver 201 converts an external clock rate of the digital data transmitted from the application processor HOS into an internal clock rate for the internal digital data. For example, a write operation of the interface receiver 201 is synchronized with the external clock and a read operation of the interface receiver 201 is synchronized with the internal clock.

The timing controller 213 may be configured by logic circuits and an application which controls the logic circuits or by hardware configuration including a logic circuit, a counter and the like. The timing controller 213 can set the operation mode and the operation sequence of the liquid crystal driver IC1, and change the operation mode. Examples of the operation mode include the display period DWT including the write period in which the pixel signal is written to the pixel of each horizontal line, the touch detection period TDT (non-display period), and the like. For this reason, the timing controller 213 can refer to an external horizontal synchronization signal HSYNC from the interface receiver 201 and synchronize with the external horizontal synchronization signal HSYNC. Then, the timing controller 213 generates various types of timing pulses to implement various types of operations, based on an internal clock from an oscillator 214.

Various types of timing pulses for display control that are output from the timing controller 213 are input to the video memory 202, the line latch circuit 203, the source amplifier 204 and a panel control signal generator 220. Furthermore, various types of timing pulses for sensor from the timing controller 213 are also input to a touch detection element control signal generator 231 and a touch interface 232.

The panel control signal generator 220 generates drive signals for the gate drive circuit GD and the common electrode drive circuit CD, and implements the video display on the liquid crystal display panel LCD.

The touch detection element control signal generator 231 can supply the drive signals Tx1, Tx2, Tx3, . . . to the common electrodes C. The touch panel controller IC2 and the touch interface 232 are electrically connected with each other and have the operation timing synchronized with each other. In other words, the touch panel controller IC2 can recognize the touch detection periods TDT and receive the detection signals Rxs in the touch detection periods TDT. The touch panel controller IC2 communicates with the touch detection element control signal generator 231 via the touch interface 232 and recognizes operation conditions of the touch detection element control signal generator 231, for example, the drive conditions of the touch detection elements and the like.

In the above-explained configuration, a block including the panel control signal generator 220, the touch detection element control signal generator 231, the timing controller 213, the oscillator 241 and the like may be referred to as a scanning driver 242. The scanning driver 242 thus includes a second clock generator (oscillator 214) and can sequentially supply the pixel signals and the display drive signals to display elements in time division, synchronously with a clock of the second clock generator, to execute display scanning. Furthermore, the scanning driver 242 supplies the drive signals for touch detection to the touch detection elements.

In the above-explained configuration, a block including the touch interface 232, the touch panel controller IC2 and the like may be referred to as a touch detector 243. The touch detector 243 can execute touch detection by sampling the detection signals Rxs from the touch detection elements Rx.

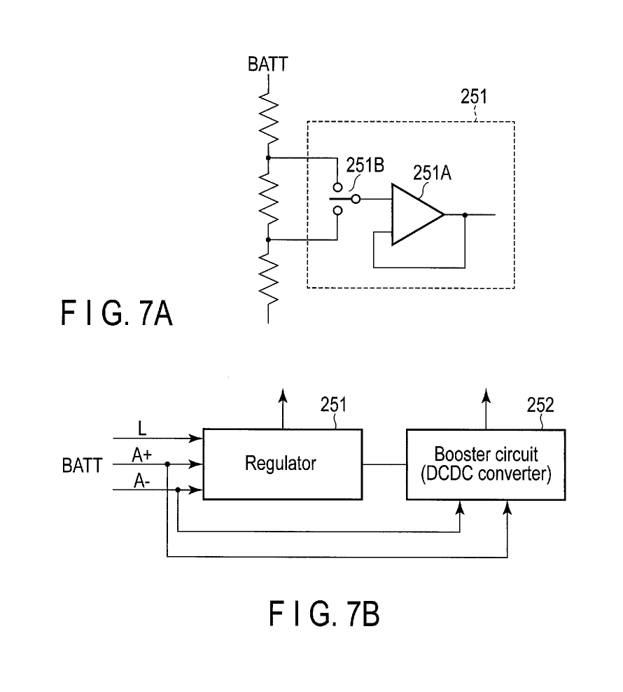

The liquid crystal driver IC1 includes a regulator 251 and a booster circuit 252 which may be referred to as a charge pump, as power supply modules for the internal circuits. As shown in FIG. 7(a), for example, the regulator 251 receives the power supply from a battery BATT and generates the drive voltage by an output amplifier 251A for output stabilization. The regulator 251 can selectively take plural, for example, two potential voltages from the battery BATT. In other words, the regulator 251 includes a changeover switch 251B and an amplifier 251A for output stabilization, and selects the input potential in response to the control signal, at the changeover switch 251B. The drive voltage output from the regulator 251 is supplied to the interface receiver 201, the video memory 202, the line latch circuit 203, the timing controller 213 and the oscillator 214. The booster circuit 252 is composed of, for example, DCDC converter, receives the power supply from the regulator 251 as shown in FIG. 7(b), boosts a direct-current voltage to a predetermined voltage by controlling a boost frequency, and outputs the voltage to the source amplifier 204, the panel control signal generator 220 and the touch detection element control signal generator 231. Each of the circuit blocks thereby operates properly in the liquid crystal driver IC1.

In general, the battery BATT includes a power output circuit, and the power output circuit is designed to output logic power, positive-side analog power and negative-side analog power in a predetermined sequence.

In the display device of the present embodiment, the sequence of turning on the power supplied to the liquid crystal driver IC1 is monitored. In general, plural types of power are turned on at the power-on or the like, in the liquid crystal driver IC1, but are often turned on not in the predetermined sequence, but in a wrong sequence. At this time, the liquid crystal driver IC1 often turns off a sleep status (sleeps out) and starts a boosting operation, although it is detected that the sequence of turning on the power is wrong. As a result, inconvenience that a large current unexpectedly flows to each module inside the liquid crystal driver IC1, i.e., a latch-up occurs, the liquid crystal driver IC1 does not operate normally or the like, may occur.

In the present embodiment, a monitoring circuit 260 configured to monitor the sequence of turning on the power supplied to the liquid crystal driver IC1 is provided as shown in FIG. 6. In the present embodiment, it is assumed that three types of the power are supplied to the liquid crystal driver IC1 and that these types of the power are logic power LOGIC (represented by L in FIG. 6), positive-side analog power ANALOG+ (represented by A+ in FIG. 6) and negative-side analog power ANALOG− (represented by A− in FIG. 6). In the present embodiment, a correct sequence of turning on the power supplied to the liquid crystal driver IC1 is assumed to be a sequence of the logic power, the positive-side analog power and the negative-side analog power. The correct sequence of turning on the power supplied to the liquid crystal driver IC1 is not limited to the above-mentioned sequence, but may be a sequence of, for example, the logic power, the negative-side analog power and the positive-side analog power. Definitely, however, the logic power must be first turned on.

The monitoring circuit 260 includes a detection circuit 261 and a sequence circuit 262. The monitoring circuit 260 is driven by receiving the supply of the logic power from the battery BATT.

The detection circuit 261 is a circuit detecting the liquid crystal driver IC1 having been supplied with the power. More specifically, the detection circuit 261 determines whether the status of the liquid crystal driver IC1 is an initial status (undefined status) or not by receiving the supply of the logic power to drive the monitoring circuit 260 from the battery BATT. The initial status indicates a status in which none of the logic power, the positive-side analog power and the negative-side analog power is turned on at the liquid crystal driver IC1. However, since the power to drive the monitoring circuit 260 is necessary, the detection circuit 261 determines that the status of the liquid crystal driver IC1 is the initial status, if the power to drive the monitoring circuit 260 is supplied to the liquid crystal driver IC1 but the power to drive the other modules in the liquid crystal driver IC1 is not supplied to the regulator 251 or the booster circuit 252.

If the status of the liquid crystal driver IC1 is not determined to be the initial status, the detection circuit 261 outputs a recover signal, which is represented by RCVR in FIG. 6, to the application processor HOS. The recover signal is a signal to return the status of the liquid crystal driver IC1 to the initial status, i.e., a signal to instruct the battery BATT to return the status of the liquid crystal driver IC1 to the initial status. In other words, the recover signal is a signal to urge the battery BATT to stop the supply of power to the liquid crystal driver IC1 via the application processor HOS and to return the status of the liquid crystal driver IC1 to the initial status.

The sequence circuit 262 monitors the sequence of turning on the power supplied to the liquid crystal driver IC1 after the detection circuit 261 determines that the status of the liquid crystal driver IC1 is the initial status. More specifically, the sequence circuit 262 determines whether the power supplied to the liquid crystal driver IC1 is turned on in the sequence of the logic power, the positive-side analog power and the negative-side analog power or not. If the power supplied to the liquid crystal driver IC1 is turned on in the sequence of the logic power, the positive-side analog power and the negative-side analog power, i.e., if the power is turned on in the correct sequence, the sequence circuit 262 outputs a permission signal to the application processor HOS and the interface receiver 201. The permission signal may be referred to as an Enable signal. The permission signal is a signal to permit a command to be supplied (issued) and accepted (taken in). According to this, when the application processor HOS receives the permission signal output from the sequence circuit 262, the application processor HOS issues a command to turn off the sleep status and start the boosting operation, for the interface receiver 201. In addition, when the interface receiver 201 receives the permission signal output from the sequence circuit 262, the interface receiver 201 starts taking in the command issued by the application processor HOS. In other words, when the application processor HOS does hot receive the permission signal output from the sequence circuit 262, the application processor HOS does not issue the command for the interface receiver 201 and, even if an operation error occurs in the application processor HOS and the command is issued by the application processor HOS, the interface receiver 201 does not start taking in the command.

In contrast, if the power supplied to the liquid crystal driver IC1 is not turned on in the sequence of the logic power, the positive-side analog power and the negative-side analog power, i.e., if the power is turned on in the wrong sequence, the sequence circuit 262 outputs the recover signal to the application processor HOS. Unlike the above-explained recover signal, this recover signal is not a signal to return the status of the liquid crystal driver IC1 to the initial status, but a signal to return the status of the liquid crystal driver IC1 to the status maintained before the power is turned on in the wrong sequence, in order to turn on the power at the liquid crystal driver IC1 in the correct sequence. For example, if the negative-side analog power is turned on after the logic power is turned on for the liquid crystal driver IC1, supply of the negative-side analog power from the battery BATT to the liquid crystal driver IC1 can be stopped by outputting the recover signal from the sequence circuit 262 to the application processor HOS. In other words, the status of the liquid crystal driver IC1 can be returned to the status maintained before the negative-side analog power is turned on.

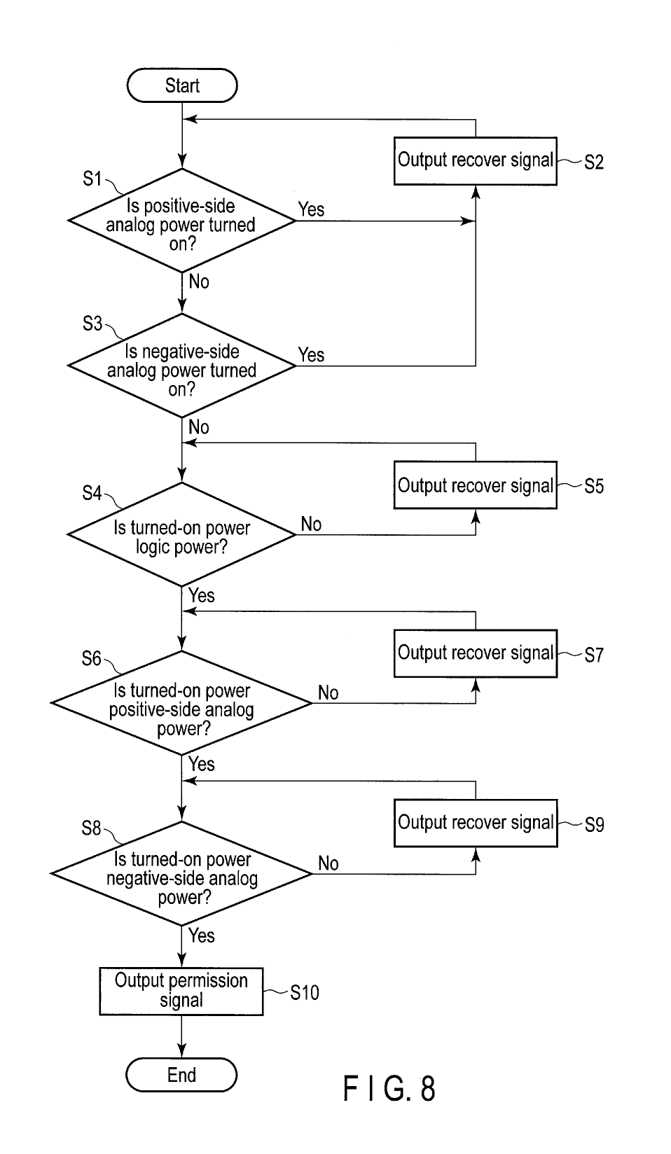

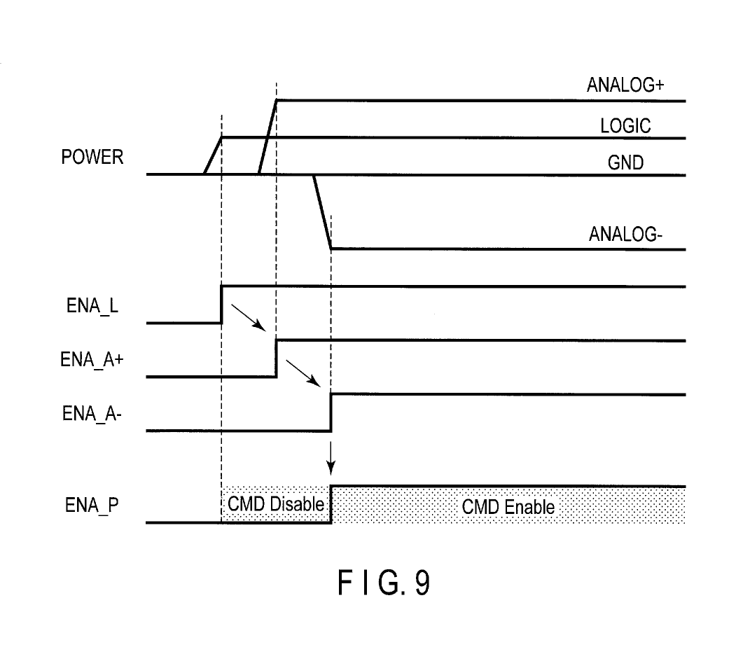

An example of operations of the monitoring circuit 260 will be explained with reference to a flow chart of FIG. 8 and a timing chart of FIG. 9. FIG. 8 is a flow chart for explanation of an example of operations of the monitoring circuit 260 and FIG. 9 is a timing chart for explanation of the example of operations of the monitoring circuit 260. It is assumed here that the logic power to drive the monitoring circuit 260 is supplied from the battery BATT to the monitoring circuit 260.

In FIG. 8, it is monitored in steps S1 to S3 whether the status of the liquid crystal driver IC1 is an initial status or not, and the sequence of turning on the logic power, the positive-side analog power and the negative-side analog power is monitored in steps S4 to S8. First, the detection circuit 261 in the monitoring circuit 260 determines whether the positive-side analog power is turned on for the liquid crystal driver IC1 by the battery BATT or not, to determine whether the status of the liquid crystal driver IC1 is the initial status or not (step S1). If it is determined that the positive-side analog power is turned on for the liquid crystal driver IC1 (YES in step S1), the detection circuit 261 outputs the recover signal to the application processor HOS (step S2) and urges the battery BATT to stop the supply of the power to the liquid crystal driver IC1 excluding the logic power to drive the monitoring circuit 260, for the purpose of returning the status of the liquid crystal driver IC1 to the initial status. After that, the processing in step S1 is executed again. If it is determined that the positive-side analog power is turned on for the liquid crystal driver IC1, the above-explained processing in step S2 is executed and then the above-explained processing in step S1 is executed again, but processing in step S4 to be explained later may be executed after the above-explained processing in step S2.

If it is determined that the positive-side analog power is not turned on for the liquid crystal driver IC1 (NO in step S1), the detection circuit 261 determines whether the negative-side analog power is turned on for the liquid crystal driver IC1 by the battery BATT or not, to confirm whether the status of the liquid crystal driver IC1 is the initial status or not (step S3), similarly to step S1. If it is determined that the negative-side analog power is turned on for the liquid crystal driver IC1 (YES in step S3), the detection circuit 261 executes the above-explained processing in step S2, urges the battery BATT to stop the supply of the power to the liquid crystal driver IC1 and executes the above-explained processing in step S1 again, for the purpose of returning the status of the liquid crystal driver IC1 to the initial status. If it is determined that the negative-side analog power is turned on for the liquid crystal driver IC1, the above-explained processing in step S2 is executed and then the above-explained processing in step S1 is executed again, but processing in step S4 to be explained later may be executed after the above-explained processing in step S2.

If it is determined that the negative-side analog power is not turned on for the liquid crystal driver IC1 (NO in step S3), the detection circuit 261 determines (detects) a situation that the status of the liquid crystal driver IC1 is the initial status. In other words, the detection circuit 261 detects a situation that the power (POWER) in FIG. 9 is in a status of GND. If the status of the liquid crystal driver IC1 is confirmed to be the initial status and the detection circuit 261 detects the supply of the power from the battery BATT, the sequence circuit 262 determines whether the power turned on for the liquid crystal driver IC1 by the battery BATT is the logic power or not (step S4). If it is determined that the power turned on for the liquid crystal driver IC1 is not the logic power (NO in step S4), the sequence circuit 262 outputs the recover signal to the application processor HOS (step S5) and urges the battery BATT to stop the supply of the power to the liquid crystal driver IC1, for the purpose of returning the status of the liquid crystal driver IC1 to the initial status. After that, the processing in step S4 is executed again.

If it is determined that the power turned on for the liquid crystal driver IC1 is the logic power (YES in step S4), the sequence circuit 262 determines that the power has been currently turned on in the correct sequence for the liquid crystal driver IC1. In other words, the sequence circuit 262 determines that the power has been currently turned on in the correct sequence if, of POWER in FIG. 9, the logic power (POWER) regarding LOGIC is first shifted from OFF (GND) status to ON status and a signal ENA_L in FIG. 9 indicating whether the logic power is turned on is first shifted from OFF status to ON status, i.e., 0 to 1 or LOW to HIGH.

If the logic power is confirmed to be first turned on for the liquid crystal driver IC1 and further supply of the power from the battery BATT is detected by the detection circuit 261, the sequence circuit 262 determines whether the power turned on for the liquid crystal driver IC1 by the battery BATT is the positive-side analog power or not (step S6). If it is determined that the power turned on for the liquid crystal driver IC1 is not the positive-side analog power (NO in step S6), the sequence circuit 262 outputs the recover signal to the application processor HOS (step S7) and urges the battery BATT to stop the supply of the power other than the logic power to the liquid crystal driver IC1, for the purpose of returning the status of the liquid crystal driver IC1 to the status in which the logic power alone has been turned on. After that, the processing in step S6 is executed again.

In the present embodiment, in step S7, the recover signal is output to the application processor HOS to return the status of the liquid crystal driver IC1 to the status in which the logic power alone has been turned on but, for example, the recover signal to return the status of the liquid crystal driver IC1 to the initial status may be output to the application processor HOS. In this case, not the processing in step S6, but the processing in step S4 is executed again after the processing in step S7.

If it is determined that the power turned on for the liquid crystal driver IC1 is the positive-side analog power (YES in step S6), the sequence circuit 262 determines that the power has been currently turned on in the correct sequence for the liquid crystal driver IC1. In other words, the sequence circuit 262 determines that the power has been currently turned on in the correct sequence if, of POWER in FIG. 9, the positive-side analog power (POWER) regarding ANALOG+ is shifted from OFF (GND) status to ON status, subsequently with POWER regarding LOGIC, and a signal ENA_A+ in FIG. 9 indicating whether the positive-side analog power is turned on is shifted from OFF status to ON status, i.e., 0 to 1 or LOW to HIGH, subsequently with ENA_L in FIG. 9.

If it is confirmed that the logic power is first turned on and then the positive-side analog power is turned on for the liquid crystal driver IC1 and then further supply of the power from the battery BATT is detected by the detection circuit 261, the sequence circuit 262 determines whether the power turned on for the liquid crystal driver IC1 by the battery BATT is the negative-side analog power or not (step S8). If it is determined that the power turned on for the liquid crystal driver IC1 is not the negative-side analog power (NO in step S8), the sequence circuit 262 outputs the recover signal to the application processor HOS (step S9) and urges the battery BATT to stop the supply of the power other than the logic power and the positive-side analog power to the liquid crystal driver IC1, for the purpose of returning the status of the liquid crystal driver IC1 to the status in which two types of the power have been turned on in the sequence of the logic power and the positive-side analog power, i.e., the status immediately before the processing in step S8. After that, the processing in step S8 is executed again.

In the present embodiment, in step S9, the recover signal is output to the application processor HOS to return the status of the liquid crystal driver IC1 to the status in which the two types of the power have been turned on in the sequence of the logic power and the positive-side analog power but, for example, the recover signal to return the status of the liquid crystal driver IC1 to the initial status may be output to the application processor HOS. In this case, not the processing in step S8, but the processing in step S4 is executed again after the processing in step S9.

If it is determined that the power turned on for the liquid crystal driver IC1 is the negative-side analog power (YES in step S8), the sequence circuit 262 determines that the power has been currently turned on in the correct sequence for the liquid crystal driver IC1. In other words, the sequence circuit 262 determines that all the types of power have been turned on in the correct sequence if, of POWER in FIG. 9, the negative-side analog power (POWER) regarding ANALOG− is shifted from OFF (GND) status to ON status, subsequently with POWER regarding ANALOG+, and a signal ENA_A− in FIG. 9 indicating whether the negative-side analog power is turned on is shifted from OFF status to ON status, i.e., 0 to 1 or LOW to HIGH, subsequently with ENA_L and ENA_A+ in FIG. 9.

If it is confirmed that the power has been turned on in the correct sequence for the liquid crystal driver IC1, the sequence circuit 262 outputs the permission signal to the application processor HOS and the interface receiver 201 (step S10) and ends a sequence of the processing. The signal ENA_P in FIG. 9 indicating whether the interface receiver 201 is enabled to take in the command is thereby shifted from OFF status to ON status, i.e., 0 to 1 or LOW to HIGH.

If the application processor HOS has accepted the recover signal in the same processing steps at a predetermined number of times, the application processor HOS may output a specific abnormal sound from a speaker or blink a specific light-emitting element to notify the user that the liquid crystal driver IC1 is disabled to take in various commands.

The correct sequence of turning on the power supplied to the liquid crystal driver IC1 is the sequence of the logic power, the positive-side analog power and the negative-side analog power, but may be the sequence of the logic power, the negative-side analog power and the positive-side analog power. In this case, the processing in step S8 is executed instead of the processing in step S6 by the sequence circuit 262, and the processing in step S6 is executed instead of the processing in step S8 by the sequence circuit 262. Thus, an advantage of reducing paths in which the overcurrent flows can be obtained by setting the sequence of turning on the negative-side analog power and then the positive-side analog power to be the correct sequence of turning on the power, as compared with the sequence of turning on the positive-side analog power and then the negative-side analog power.

Furthermore, the correct sequence of turning on the power supplied to the liquid crystal driver IC1 is the sequence of the logic power, the positive-side analog power and the negative-side analog power, and the sequence circuit 262 sequentially determines which type of power has been turned on, i.e., sequentially executes of the processing in steps S4, S6 and S8, but the processing of determining whether the turned-on power is the logic power or not, i.e., the processing in step S4 may be omitted. In this case, the processing in step S5 may be omitted together with the processing in step S4. According to this, an advantage of diminishing an operation failure resulting from an undefined status which may often occur by determining whether the logic power has been turned on or not can be obtained.

According to the above-explained first embodiment, the liquid crystal driver IC1 comprises the monitoring circuit 260 capable of outputting the permission signal which enables the application processor HOS to supply (issue) the command and enables the interface receiver 201 to take in the command, only when the power is turned on in the correct sequence. Thus, occurrence of the latch-up in the liquid crystal driver IC1 can be prevented and inconvenience that the liquid crystal driver IC1 does not operate normally or the like can be reduced.

### Second Embodiment

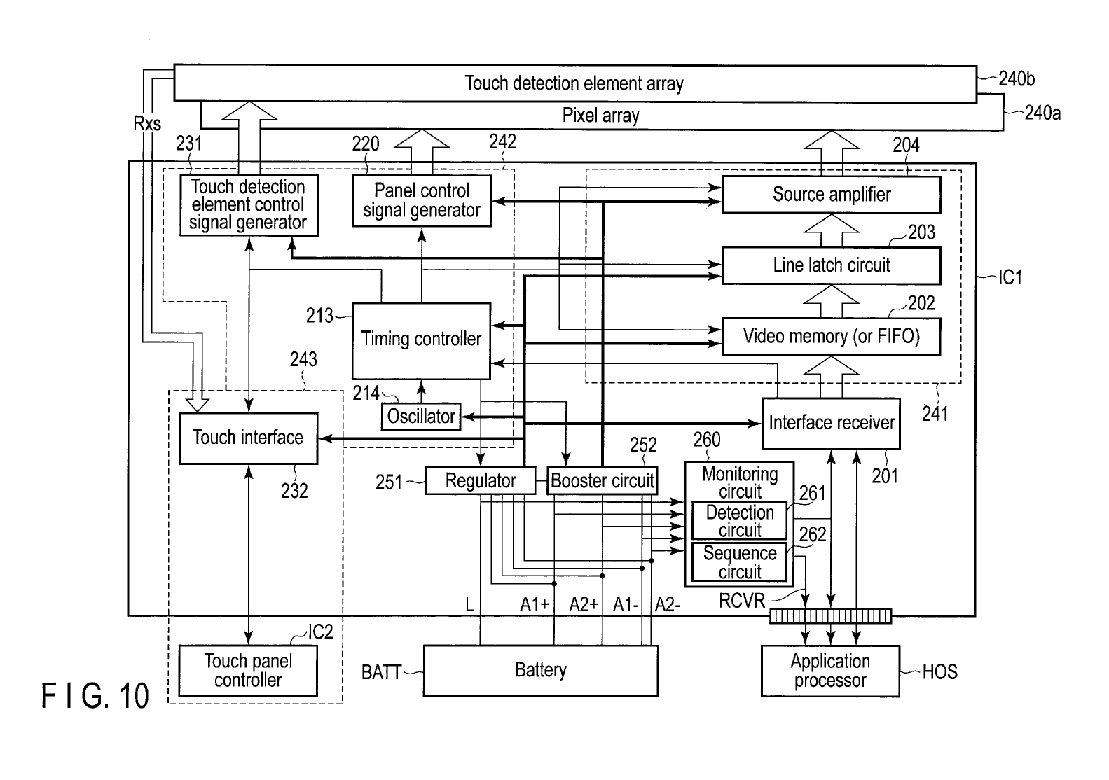

Next, a second embodiment will be explained. In the second embodiment, unlike the first embodiment, the power supplied from the battery BATT to the liquid crystal driver IC1 is not three types of power that are logic power, positive-side analog power and negative-side analog power, but five types of power that are the logic power, first positive-side analog power, second positive-side analog power, first negative-side analog power and second negative-side analog power as shown in FIG. 10. Basic configuration and functions of a monitoring circuit 260 are not explained in detail here since they are the same as those of the first embodiment. Operations of the monitoring circuit 260 in a case where the above-explained five types of power are supplied from the battery BATT to the liquid crystal driver IC1 will be mainly hereinafter explained.

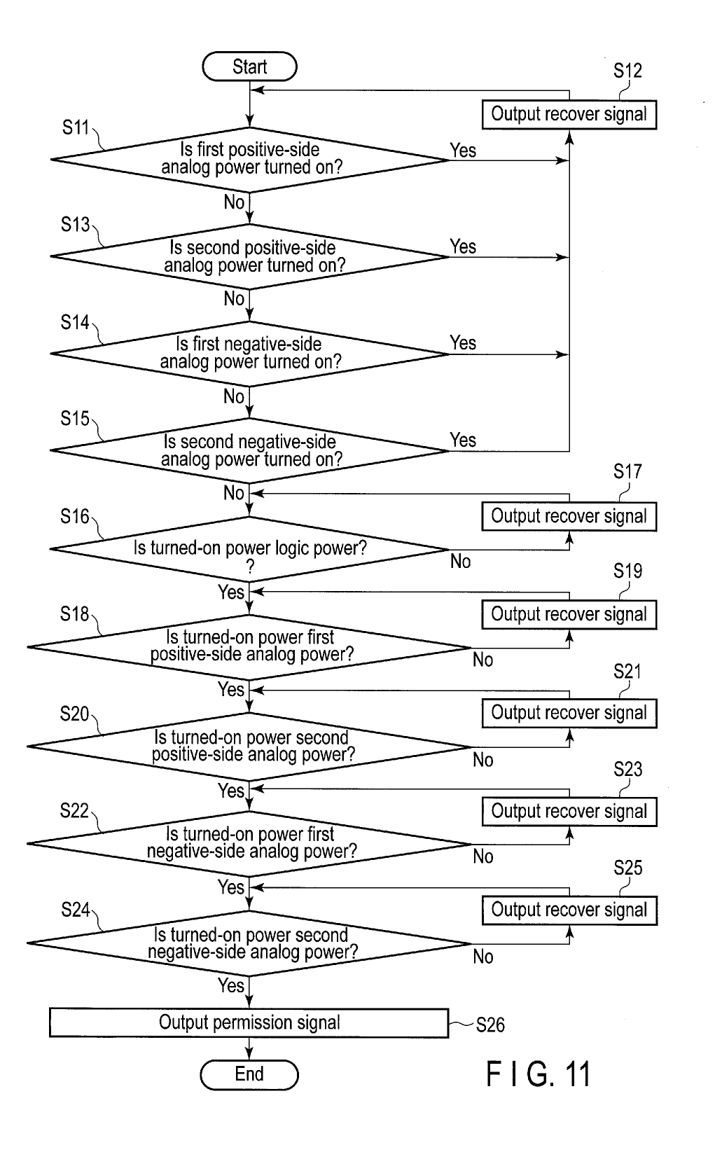

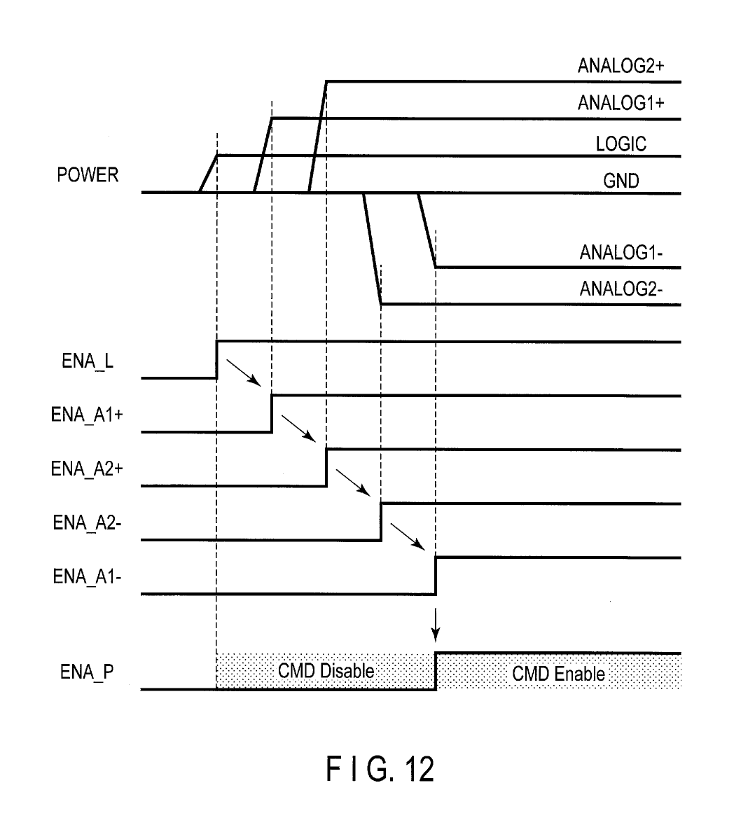

FIG. 11 is a flow chart for explanation of an example of operations of the monitoring circuit 260 of the second embodiment and FIG. 12 is a timing chart for explanation of the example of operations of the monitoring circuit 260 of the second embodiment. In the present embodiment, a correct sequence of turning on the power supplied to the liquid crystal driver IC1 is assumed to be a sequence of the logic power, the first positive-side analog power, the second positive-side analog power, the first negative-side analog power, and the second negative-side analog power.

First, a detection circuit 261 in the monitoring circuit 260 determines whether the first positive-side analog power has been turned on for the liquid crystal driver IC1 or not, to determine whether a status of the liquid crystal driver IC1 is an initial status or not (step S11). If it is determined that the first positive-side analog power has been turned on for the liquid crystal driver IC1 (YES in step S11), the detection circuit 261 outputs a recover signal to an application processor HOS (step S12) and urges the battery BATT to stop the supply of the power to the liquid crystal driver IC1 excluding the logic power to drive the monitoring circuit 260, for the purpose of returning the status of the liquid crystal driver IC1 to the initial status. After that, the processing in step S11 is executed again.

If it is determined that the first positive-side analog power has not been turned on for the liquid crystal driver IC1 (NO in step S11), the detection circuit 261 determines whether the second positive-side analog power has been turned on for the liquid crystal driver IC1 or not, to determine whether the status of the liquid crystal driver IC1 is the initial status or not (step S13), similarly to step S11. If it is determined that the second positive-side analog power has been turned on for the liquid crystal driver IC1 (YES in step S13), the detection circuit 261 executes the above-explained processing in step S12, urges the battery BATT to stop the supply of the power to the liquid crystal driver IC1 and executes the above-explained processing in step S11 again, for the purpose of returning the status of the liquid crystal driver IC1 to the initial status.

If it is determined that the second positive-side analog power has not been turned on for the liquid crystal driver IC1 (NO in step S13), the detection circuit 261 determines whether the second positive-side analog power has been turned on for the liquid crystal driver IC1 or not, to determine whether the status of the liquid crystal driver IC1 is the initial status or not (step S14), similarly to steps S11 and S13. If it is determined that the first negative-side analog power has been turned on for the liquid crystal driver IC1 (YES in step S14), the detection circuit 261 executes the above-explained processing in step S12, urges the battery BATT to stop the supply of the power to the liquid crystal driver IC1 and executes the above-explained processing in step S11 again, for the purpose of returning the status of the liquid crystal driver IC1 to the initial status.

If it is determined that the first negative-side analog power has not been turned on for the liquid crystal driver IC1 (NO in step S14), the detection circuit 261 determines whether the second negative-side analog power has been turned on for the liquid crystal driver IC1 or not, to determine whether the status of the liquid crystal driver IC1 is the initial status or not (step S15), similarly to steps S11, S13 and S14. If it is determined that the second negative-side analog power has been turned on for the liquid crystal driver IC1 (YES in step S15), the detection circuit 261 executes the above-explained processing in step S12, urges the battery BATT to stop the supply of the power to the liquid crystal driver IC1 and executes the above-explained processing in step S11 again, for the purpose of returning the status of the liquid crystal driver IC1 to the initial status.

If it is determined that the second negative-side analog power has not been turned on for the liquid crystal driver IC1 (NO in step S15), the detection circuit 261 determines (detects) a situation that the status of the liquid crystal driver IC1 is the initial status. In other words, the detection circuit 261 detects a situation that the power (POWER) in FIG. 12 is in a status of GND. If the status of the liquid crystal driver IC1 is confirmed to be the initial status and the detection circuit 261 detects the supply of the power from the battery BATT, the sequence circuit 262 determines whether the power turned on for the liquid crystal driver IC1 by the battery BATT is the logic power or not (step S16). If it is determined that the power turned on for the liquid crystal driver IC1 is not the logic power (NO in step S16), the sequence circuit 262 outputs the recover signal to the application processor HOS (step S17) and urges the battery BATT to stop the supply of the power to the liquid crystal driver IC1, for the purpose of returning the status of the liquid crystal driver IC1 to the initial status. After that, the processing in step S16 is executed again.

If it is determined that the power turned on for the liquid crystal driver IC1 is the logic power (YES in step S16), the sequence circuit 262 determines that the power has been currently turned on in the correct sequence for the liquid crystal driver IC1. In other words, the sequence circuit 262 determines that the power has been currently turned on in the correct sequence if, of POWER in FIG. 12, the logic power (POWER) regarding LOGIC is first shifted from OFF (GND) status to ON status and a signal ENA_L in FIG. 12 indicating whether the logic power is turned on is first shifted from OFF status to ON status, i.e., 0 to 1 or LOW to HIGH.

If the logic power is confirmed to be first turned on for the liquid crystal driver IC1 and further supply of the power from the battery BATT is detected by the detection circuit 261, the sequence circuit 262 determines whether the power turned on for the liquid crystal driver IC1 by the battery BATT is the first positive-side analog power or not (step S18). If it is determined that the power turned on for the liquid crystal driver IC1 is not the first positive-side analog power (NO in step S18), the sequence circuit 262 outputs the recover signal to the application processor HOS (step S19) and urges the battery BATT to stop the supply of the power other than the logic power to the liquid crystal driver IC1, for the purpose of returning the status of the liquid crystal driver IC1 to the status in which the logic power alone is turned on. After that, the processing in step S18 is executed again.

If it is determined that the power turned on for the liquid crystal driver IC1 is the first positive-side analog power (YES in step S18), the sequence circuit 262 determines that the power has been currently turned on in the correct sequence for the liquid crystal driver IC1. In other words, the sequence circuit 262 determines that the power has been currently turned on in the correct sequence if, of POWER in FIG. 12, the first positive-side analog power (POWER) regarding ANALOG1+ is shifted from OFF (GND) status to ON status, subsequently with POWER regarding LOGIC, and a signal ENA_A1+ in FIG. 12 indicating whether the first positive-side analog power is turned on is shifted from OFF status to ON status, i.e., 0 to 1 or LOW to HIGH, subsequently with ENA_L in FIG. 12.

If it is confirmed that the logic power is first turned on and then the positive-side analog power is turned on for the liquid crystal driver IC1 and then further supply of the power from the battery BATT is detected by the detection circuit 261, the sequence circuit 262 determines whether the power turned on for the liquid crystal driver IC1 by the battery BATT is the second positive-side analog power or not (step S20). If it is determined that the power turned on for the liquid crystal driver IC1 is not the second positive-side analog power (NO in step S20), the sequence circuit 262 outputs the recover signal to the application processor HOS (step S21) and urges the battery BATT to stop the supply of the power other than the logic power and the first positive-side analog power to the liquid crystal driver IC1, for the purpose of returning the status of the liquid crystal driver IC1 to the status in which two types of the power have been turned on in the sequence of the logic power and the first positive-side analog power, i.e., the status immediately before the processing in step S20. After that, the processing in step S20 is executed again.

If it is determined that the power turned on for the liquid crystal driver IC1 is the second positive-side analog power (YES in step S20), the sequence circuit 262 determines that the power has been currently turned on in the correct sequence for the liquid crystal driver IC1. In other words, the sequence circuit 262 determines that the power has been currently turned on in the correct sequence if, of POWER in FIG. 12, the second positive-side analog power (POWER) regarding ANALOG2+ is shifted from OFF (GND) status to ON status, subsequently with POWER regarding LOGIC and ANALOG1+, and a signal ENA_A2+ in FIG. 12 indicating whether the second positive-side analog power is turned on is shifted from OFF status to ON status, i.e., 0 to 1 or LOW to HIGH, subsequently with ENA_L and ENA_A1+ in FIG. 12.

If it is confirmed that the logic power has been first turned on, then the first positive-side analog power has been turned on and the second positive-side analog power has been turned on for the liquid crystal driver IC1 and then further supply of the power from the battery BATT is detected by the detection circuit 261, the sequence circuit 262 determines whether the power turned on for the liquid crystal driver IC1 by the battery BATT is the first negative-side analog power or not (step S22). If it is determined that the power turned on for the liquid crystal driver IC1 is not the first negative-side analog power (NO in step S22), the sequence circuit 262 outputs the recover signal to the application processor HOS (step S23) and urges the battery BATT to stop the supply of the power other than the logic power, the first positive-side analog power and the second positive-side analog power to the liquid crystal driver IC1, for the purpose of returning the status of the liquid crystal driver IC1 to the status immediately before the processing in step S22. After that, the processing in step S22 is executed again.

If it is determined that the power turned on for the liquid crystal driver IC1 is the first negative-side analog power (YES in step S22), the sequence circuit 262 determines that the power has been currently turned on in the correct sequence for the liquid crystal driver IC1. In other words, the sequence circuit 262 determines that the power has been currently turned on in the correct sequence if, of POWER in FIG. 12, the first negative-side analog power (POWER) regarding ANALOG1− is shifted from OFF (GND) status to ON status, subsequently with POWER regarding LOGIC, ANALOG1+ and ANALOG2+, and a signal ENA_A1− in FIG. 12 indicating whether the first negative-side analog power is turned on is shifted from OFF status to ON status, i.e., 0 to 1 or LOW to HIGH, subsequently with ENA_L, ENA_A1+ and ENA_A2+ in FIG. 12.

If it is confirmed that the logic power has been first turned on, then the first positive-side analog power has been turned on, the second positive-side analog power has been turned on and the first negative-side analog power is turned on for the liquid crystal driver IC1 and then further supply of the power from the battery BATT is detected by the detection circuit 261, the sequence circuit 262 determines whether the power turned on for the liquid crystal driver IC1 by the battery BATT is the second negative-side analog power or not (step S24). If it is determined that the power turned on for the liquid crystal driver IC1 is not the second negative-side analog power (NO in step S24), the sequence circuit 262 outputs the recover signal to the application processor HOS (step S25) and urges the battery BATT to stop the supply of the power other than the logic power to the liquid crystal driver IC1, for the purpose of returning the status of the liquid crystal driver IC1 to the status immediately before the processing in step S22. After that, the processing in step S24 is executed again.

If it is determined that the power turned on for the liquid crystal driver IC1 is the second negative-side analog power (YES in step S24), the sequence circuit 262 determines that the power has been currently turned on in the correct sequence for the liquid crystal driver IC1. In other words, the sequence circuit 262 determines that all the types of power have been currently turned on in the correct sequence if, of POWER in FIG. 12, the second negative-side analog power (POWER) regarding ANALOG2− is shifted from OFF (GND) status to ON status, subsequently with POWER regarding LOGIC, ANALOG1+, ANALOG2+ and ANALOG1−, and a signal ENA_A2− in FIG. 12 indicating whether the second negative-side analog power is turned on is shifted from OFF status to ON status, i.e., 0 to 1 or LOW to HIGH, subsequently with ENA_L, ENA_A1+, ENA_A2+ and ENA_A1− in FIG. 12.

If it is confirmed that the power has been turned on in the correct sequence for the liquid crystal driver IC1, the sequence circuit 262 outputs the permission signal to the application processor HOS and the interface receiver 201 (step S26) and ends a sequence of the processing. The signal ENA_P in FIG. 12 indicating whether the interface receiver 201 is enabled to take in the command is thereby shifted from OFF status to ON status, i.e., 0 to 1 or LOW to HIGH.

If the application processor HOS has accepted the recover signal in the same processing steps at a predetermined number of times, the application processor HOS may output a specific abnormal sound from a speaker or blink a specific light-emitting element to notify the user that the liquid crystal driver IC1 is disabled to take in various commands.

The correct sequence of turning on the power supplied to the liquid crystal driver IC1 is the sequence of the logic power, the first positive-side analog power, the second positive-side analog power, the first negative-side analog power and the second negative-side analog power, but may be the sequence of the logic power, the first negative-side analog power, the second negative-side analog power, the first positive-side analog power and the second positive-side analog power. In this case, the processing in step S22 is executed instead of the processing in step S18 by the sequence circuit 262, the processing in step S24 is executed instead of the processing in step S20 by the sequence circuit 262, the processing in step S18 is executed instead of the processing in step S22 by the sequence circuit 262, and the processing in step S20 is executed instead of the processing in step S24 by the sequence circuit 262. Thus, an advantage of reducing paths in which the overcurrent flows can be obtained by setting the sequence of turning on the first and second negative-side analog power and then the first and second positive-side analog power to be the correct sequence of turning on the power, as compared with the sequence of turning on the first and second positive-side analog power and then the first and second negative-side analog power.

Furthermore, the correct sequence of turning on the power supplied to the liquid crystal driver IC1 is the sequence of the logic power, the first positive-side analog power, the second positive-side analog power, the first negative-side analog power and the second negative-side analog power, and the sequence circuit 262 sequentially determines which type of power has been turned on, i.e., sequentially executes of the processing in steps S16, S18, S20, S22 and S24, but the processing of determining whether the turned-on power is the logic power or not, i.e., the processing in step S16 may be omitted. In this case, the processing in step S17 may be omitted together with the processing in step S16. According to this, an advantage of diminishing an operation failure resulting from an undefined status which may often occur by determining whether the logic power has been turned on or not can be obtained.

According to the above-explained second embodiment, occurrence of the latch-up in the liquid crystal driver IC1 can be prevented and inconvenience that the liquid crystal driver IC1 does not operate normally or the like can be reduced, similarly to the first embodiment, even if the battery BATT includes not three types of power, but five types of power.

### Modified Example

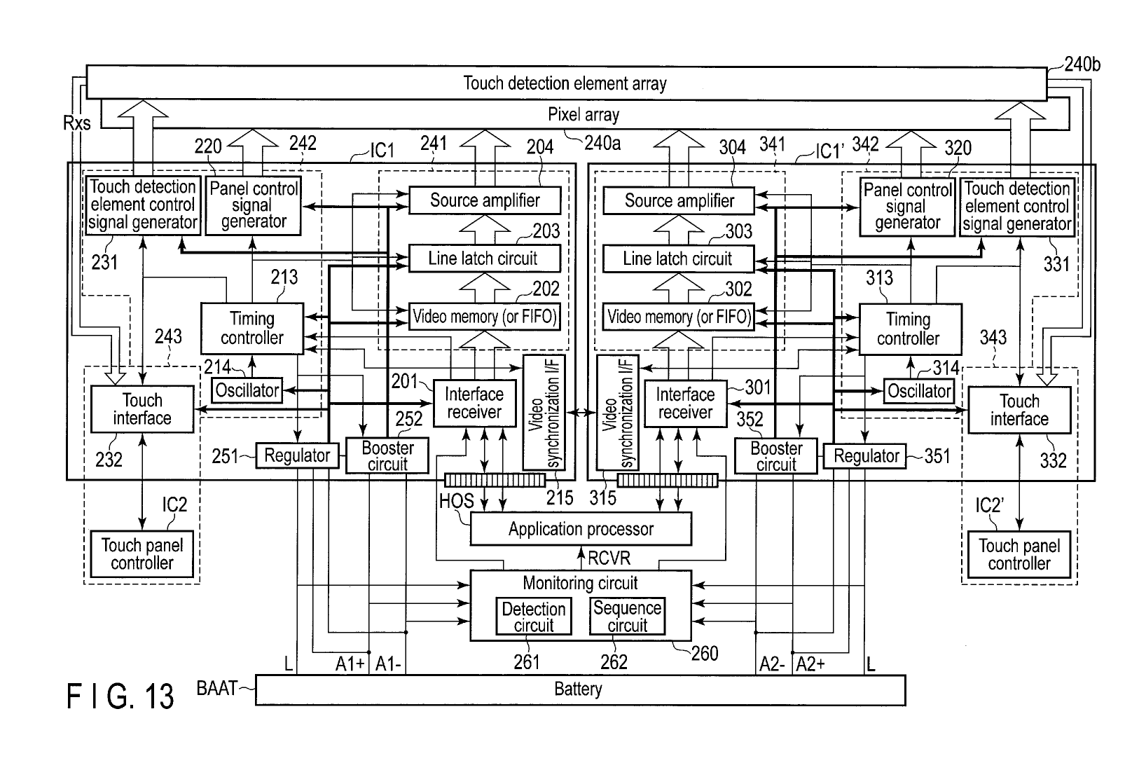

A modified example of the second embodiment will be explained. In the modified example, unlike the configuration shown in FIG. 10, the display area DA is divided into two areas and liquid crystal drivers are disposed in the respective divided areas, i.e., a dual-chip configuration including two liquid crystal drivers IC1 and IC1′ as shown in FIG. 13 is assumed. Similarly to the liquid crystal driver IC1, the liquid crystal driver IC1′ includes an interface receiver 301, a video memory 302, a line latch circuit 303, a source amplifier 304, a timing controller 313, an oscillator 314, a panel control signal generator 320, a touch detection element control signal generator 331, a touch interface 332, a regulator 351, a booster circuit 352 and the like. In addition, video synchronization interfaces 215 and 315 are disposed in the liquid crystal drivers IC1 and IC1′, respectively, such that video data in the liquid crystal drivers IC1 and IC1′ can be processed and outputs of the video signals from the liquid crystal drivers IC1 and IC1′ can be synchronized with each other.

In the dual-chip configuration shown in FIG. 13, the monitoring circuit 260 may be disposed outside the liquid crystal drivers IC1 and IC1′ or may be disposed in either of the liquid crystal drivers IC1 and IC1′. In FIG. 13, the monitoring circuit 260 is disposed outside the liquid crystal drivers IC1 and IC1′.

If the monitoring circuit 260 is disposed outside the liquid crystal drivers IC1 and IC1′, the first liquid crystal driver IC1 is supplied with the logic power, the first positive-side analog power and the first negative-side analog power from the battery BATT as shown in FIG. 13. The second liquid crystal driver IC1′ is supplied with the logic power, the second positive-side analog power and the second negative-side analog power from the battery BATT as shown in FIG. 13.

In contrast, if the monitoring circuit 260 is disposed in the liquid crystal driver IC1, of the liquid crystal drivers IC1 and IC1′, the first liquid crystal driver IC1 is supplied with the logic power, the first positive-side analog power and the first negative-side analog power from the battery BATT. The second liquid crystal driver IC1′ is supplied with the logic power, the second positive-side analog power and the second negative-side analog power, indirectly, via the first liquid crystal driver IC1.

In any one of the cases, the monitoring circuit 260 can monitor the sequence of turning on various types of power by being supplied with various types of power. In other words, the monitoring circuit 260 can execute the same processing as that explained with reference to FIG. 11. According to this, the same advantages as those of the second embodiment can be obtained from the dual-chip configuration as shown in FIG. 13.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device, comprising:
a display which displays an image; and
a driver which supplies a drive signal to the display,
the driver determining, if power to drive the driver is supplied from power sources, whether a sequence of supplying the power is a predetermined sequence,
a status of the driver remaining as a status in which various commands are unacceptable in the case being determined that the sequence of supplying the power is not the predetermined sequence,
the status of the driver being shifted to a status in which the various commands supplied to the driver are acceptable in the case being determined that the sequence of supplying the power is the predetermined sequence.

2. The display device of claim 1, wherein
if the power is supplied from a logic power source and an analog power source different from the logic power source, the driver determines whether the power of the logic power source is supplied first and the power of the analog power source consecutively or not.

3. The display device of claim 1, wherein
if it is determined that the sequence of supplying the power is not the predetermined sequence, the driver outputs a recover signal to instruct the power sources to supply the power to the driver in the predetermined sequence, to a processor which supplies the various commands to the driver.

4. The display device of claim 3, wherein
if it is determined that the sequence of supplying the power is not the predetermined sequence since the sequence is wrong in middle part, the driver outputs to the processor the recover signal to instruct the power supplied in the wrong sequence to be supplied to the driver in a correct sequence, without stopping supply of the power supplied in the correct sequence.

5. The display device of claim 1, wherein
if it is determined that the sequence of supplying the power is the predetermined sequence, the driver outputs a permission signal to permit the various commands to be supplied, to a processor which supplies the various commands to the driver.

6. A display device, comprising:
a display which displays an image;
a driver which supplies a drive signal to the display; and
an interface receiver disposed in the driver, which accepts a command from an application processor,
the driver comprising:
a regulator which receives first power from a battery and generates stable logic power;
a booster circuit which receives positive second power and negative third power from the battery and generates positive and negative analog power boosted; and
a monitoring circuit which determines supply statuses of the first, second and third power output from the battery and, only if the sequence of supplying the power is correct, permits the interface receiver to accept the command from the application processor.

7. The display device of claim 6, wherein
the booster circuit further receives positive fourth power and negative fifth power from the battery, and
the monitoring circuit sequentially determines supply statuses of the first to fifth power output from the battery and, only if the sequence of supplying the power is correct, permits the interface receiver to accept the command from the application processor.

8. The display device of claim 6, wherein
if the sequence of supplying the power is abnormal, the monitoring circuit outputs a recover signal to instruct the battery to supply the power in a correct sequence, to the application processor.

9. The display device of claim 7, wherein
if the sequence of supplying the power is abnormal, the monitoring circuit outputs a recover signal to instruct the battery to supply the power in a correct sequence, to the application processor.

10. The display device of claim 8, wherein
the application processor issues an alert if the application processor receives the recover signal at a predetermined number of times.

11. The display device of claim 9, wherein
the application processor issues an alert if the application processor receives the recover signal at a predetermined number of times.

12. A display device, comprising:
a first display which displays an image in a first display area inside a display area in which an image is capable of being displayed;
a second display which displays an image in a second display area different from the first display area;
a first driver which supplies a drive signal to the first display;
a second driver which supplies a drive signal to the second display;
a first interface receiver disposed in the first driver, which accepts a command from an application processor;
a second interface receiver disposed in the second driver, which accepts a command from the application processor; and
a monitoring circuit which determines whether the first and second interface receivers are permitted to accept the commands from the application processor,
the first and second drivers each comprising a regulator which receives first power from a battery and generates stable logic power,
the first driver further comprising a first booster circuit which receives positive second power and negative third power from the battery and generates positive and negative analog power boosted,
the second driver further comprising a second booster circuit which receives positive fourth power and negative fifth power from the battery and generates positive and negative analog power boosted,
the monitoring circuit determining supply statuses of the first to fifth power output from the battery in a predetermined sequence and, only if the sequence of supplying the power is correct, permits the first and second interface receivers to accept the commands from the application processor.

13. The display device of claim 12, wherein
if the sequence of supplying the power is abnormal, the monitoring circuit outputs to the application processor a recover signal to instruct the battery to supply the power in a correct sequence.
